(19) United States
(12) Patent Application Publication
(10) Pub. No.: US 2013/0270973 A1
(43) Pub. Date: Oct. 17, 2013

(54) ROTARY ELECTRIC MACHINE

(71) Applicant: Masayuki Ikemoto, Anjo-shi (JP)

(72) Inventor: Masayuki Ikemoto, Anjo-shi (JP)

(73) Assignee: Toyota Jidosha Kabushiki Kaisha, Toyota-shi (JP)

(21) Appl. No.: 13/827,801

(22) Filed: Mar. 14, 2013

(30) Foreign Application Priority Data
Apr. 11, 2012 (JP) 2012-089831

(51) Int. Cl. H02K 11/00

(52) U.S. Cl. CPC H02K 11/0047
USPC 310/68 C

(57) ABSTRACT

A rotary electric machine includes: a coil conductor that is fitted to a core of the rotary electric machine to form a coil; a neutral line connected to a neutral point of the coil; and a temperature sensor, on which the neutral line is wound to be in contact therewith, and that detects a temperature of the neutral line, wherein the neutral line is, in a region thereof that is in contact with the temperature sensor, equal in cross-sectional area to the coil conductor.

### INCORPORATION BY REFERENCE

The disclosure of Japanese Patent Application No. 2012-089831 filed on Apr. 11, 2012 including the specification, drawings and abstract is incorporated herein by reference in its entirety.

### BACKGROUND OF THE INVENTION

1. Field of the Invention

The invention relates to a rotary electric machine, and more particularly, to a structure regarding the measurement of a temperature of a coil of a rotary electric machine.

2. Description of Related Art

There are known an electric motor that converts electric energy into rotational kinetic energy, a generator that converts rotational kinetic energy into electric energy, and moreover, an electric machine that functions as both an electric motor and a generator. Each of these electric machines will be referred to hereinafter as a rotary electric machine.

The rotary electric machine has two members that are arranged coaxially with each other and rotate relatively to each other. In general, one of the members is fixed, and the other rotates. A coil is arranged in the fixed member (a stator), and is supplied with electric power to form a rotating magnetic field. Due to the interaction with this magnetic field, the other member (a rotor) rotates.

As the rotary electric machine operates, it generates heat, and the temperature thereof rises. This rise in temperature may cause inconveniences in respective portions of the rotary electric machine. In particular, the coil through which electric current flows generates a large amount of heat, and the temperature of the coil is likely to use Therefore, the temperature of the coil is monitored with a view to managing the temperature of the rotary electric machine. In Japanese Patent Application Publication No. 2008-131775 (JP-2008-131775 A), a rod-like or thin board-like neutral point terminal that constitutes a neutral point of coils of three phases is provided with a piece of board that is perpendicular to the longitudinal direction thereof. This piece of board is wound around a temperature detection element. Since the neutral point terminal is electrically connected to the coil, the same amount of electric current flows through the neutral point terminal as through the coil, and the amount of heat generated through electric current is close to that of the coil. Besides, since the aforementioned piece of board is wound around the temperature detection element, the area of contact therebetween increases, thus reducing the time delay of changes in temperature.

In JP-2008-131775 A, the neutral point terminal is provided, in a bulging manner, with the piece of board that is wound around the temperature detection element. Therefore, the cross-sectional area of the neutral point terminal is different from the cross-sectional area of a coil conductor forming the coil. Thus, the electric current density of the neutral point terminal in the region where the piece of board is provided decreases, so that the detected temperature may be different from the temperature of the coil conductor.

### SUMMARY OF THE INVENTION

It is an object of the invention to detect a temperature that is closer to a temperature of a coil conductor.

A rotary electric machine according to the invention has a coil conductor that is fitted to a core of the rotary electric machine to form a coil, a neutral line connected the coil to a neutral point, and a temperature sensor, on which the neutral line is wound to be in contact therewith and that detects a temperature of the neutral line. The neutral line is, in a region thereof that is in contact with the temperature sensor, equal in cross-sectional area to the coil conductor.

The neutral line is made, in the region thereof that is in contact with the temperature sensor, equal in cross-sectional area to the coil conductor, whereby the electric current density of a temperature detection region becomes equal to the electric current density of the coil conductor. As a result, a temperature that is closer to the temperature of the coil can be detected.

### BRIEF DESCRIPTION OF THE DRAWINGS

Features, advantages, and technical and industrial significance of an exemplary embodiment of the invention will be described below with reference to the accompanying drawings, in which like numerals denote like elements, and wherein:

FIG. 1 is an external view of a stator of a rotary electric machine as viewed from a direction of an axis of rotation thereof; and

FIG. 2 is an enlarged perspective view of an area around a neutral line and a temperature sensor.

### DETAILED DESCRIPTION OF EMBODIMENT

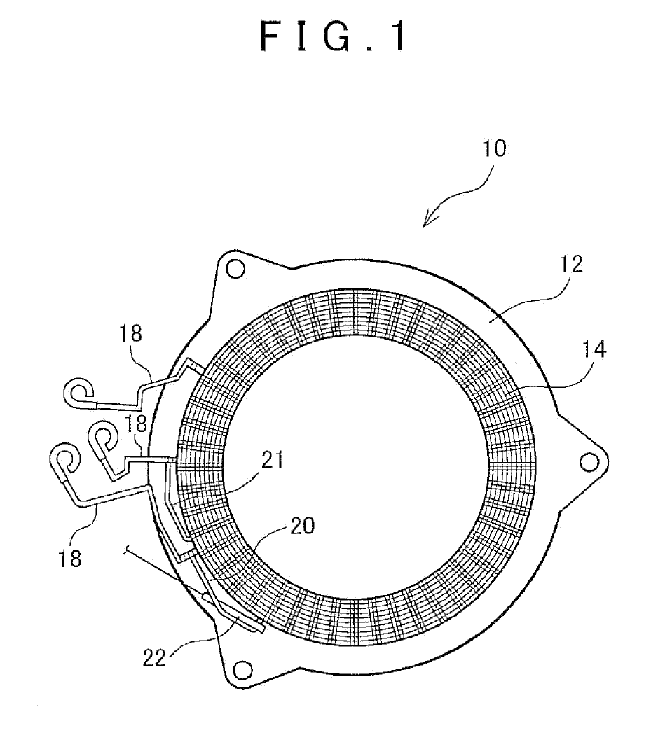

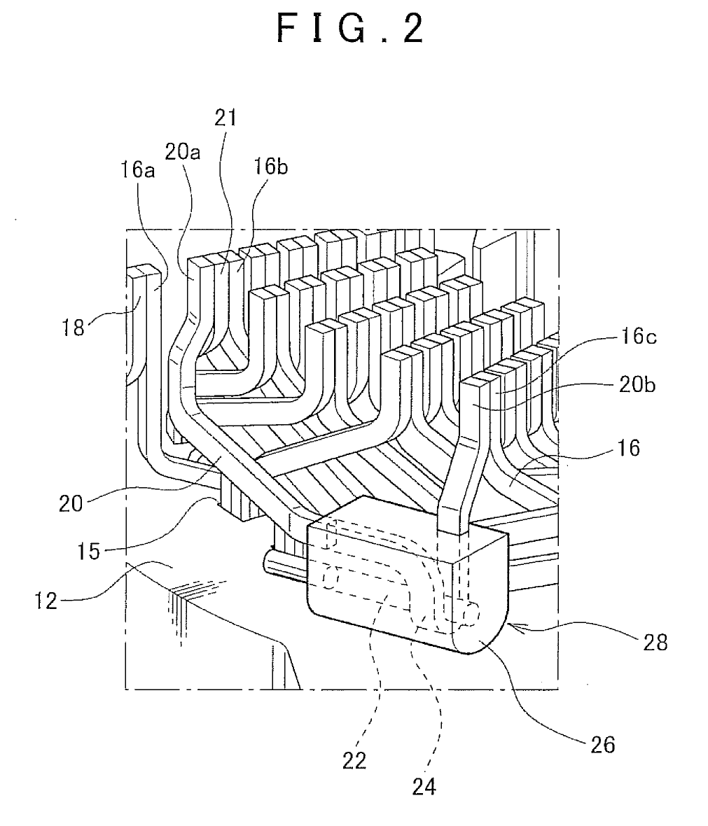

An embodiment of the invention will be described hereinafter with reference to the drawings. FIG. 1 is a diagram showing an appearance of a stator 10 of a rotary electric machine as viewed from a direction of an axis of rotation of the rotary electric machine. The stator 10 has a generally cylindrical stator core 12, and coils 14 that are wound around the stator core 12. Convex portions are arranged along a circumferential direction on an inner periphery of the cylinder of the stator core 12. Each region between adjacent ones of the convex portions is called a slot 15, and coil conductors 16 (see FIG. 2) are inserted into this slot 15. The conductor for the coil, or the coil conductor, is, for example, a flat-type conductor that is oblong in cross-section. After being bent into a predetermined shape, the coil conductor is inserted into the slot 15 and fitted thereto. The coil conductors are then welded to each other so as to form the coils 14, which are wound around the stator core 12.

The coil is provided for each phase of a three-phase alternating current, and the coil 14 of each phase is connected at one end thereof to three power lines 18 through welding or the like. Three-phase alternating-current power is supplied from the outside to the coil 14 of each phase via the power lines 18. The coil 14 of each phase is connected at the other end thereof to a neutral point by a neutral line 20. In this stator 10, two phases are connected to the single neutral line 20, and one of these two phases and the other phase are connected to each other by another neutral line 21. In this case, the end of the coil of the phase to which these two neutral lines 20 and 21 are connected serves as a neutral point. A temperature sensor 22 is arranged in contact with one of the neutral lines 20 and 21. A temperature detection element such as a thermistor or the like is in the temperature sensor 22.

FIG. 2 is an enlarged perspective view of an area around the neutral line 20 and the temperature sensor 22. As shown in FIG. 2, the coil conductor 16 extends from the slot 15 of the stator core 12, and is bent into a predetermined shape in a region thereof that is adjacent to an end face of the cylinder of the stator core 12. In this range adjacent to the stator core, ends of the coil conductors are joined to each other through welding or the like, so that the coils are formed. A region of the coil 14 that is located outside the end face of the stator core 12 is called a coil end. In this embodiment of the invention, the coils 14 wound around the convex portions that are arranged on the inner periphery of the cylinder of the stator core 12 are formed by joining a plurality of coil conductors at coil ends thereof. Then, these convex portions serve as magnetic poles.

As shown in FIG. 2, an end 16a of the coil conductor of the coil 14 of one phase is joined to the power line 18. Besides, an end 16b of the coil conductor of one phase is joined to an end 20a of the neutral line in such a manner as to sandwich the neutral line 21 therebetween. Furthermore, the neutral line 20 is connected at an end 20b thereof to an end 16c of a coil conductor of another phase. The neutral line 20 is a wire that is identical in material and equal in cross-sectional area to the coil conductor 16, and is preferably identical in cross-sectional shape thereto. The neutral line 20 extends from the one end 20a, which is joined to the end 16a of the coil conductor, in the circumferential direction on the outer periphery side of the coil end, and reaches the other end 20b. Along this extension of the neutral line 20, a winding portion 24 that is wound around the temperature sensor 22 is formed.

The winding portion 24 is formed by bending a wire constituting the neutral line 20 into a U shape in the longitudinal direction thereof. The winding portion 24 is, at an arc region thereof corresponding to the bottom of the U shape, in contact with the temperature sensor 22 in a winding manner, and surrounds this temperature sensor 22. The winding portion 24 of the neutral line is preferably shaped along the contour of the temperature sensor 22. If the temperature sensor 22 is a round bar or a cylinder, the region of the winding portion 24 that is contact with this temperature sensor 22 is made arc or circular. In the case of this embodiment of the invention, the winding portion 24 is wound around about half of the outer periphery of the temperature sensor 22. The winding portion may have shapes other than a U shape, may be wound around more than half of the outer periphery of the temperature sensor 22, and may be wound therearound in a spiral manner. When the area of contact between the neutral line 20 and the temperature sensor 22 increases, the responsiveness of temperature detection is enhanced. Besides, the area of contact may further be increased by increasing the width of the region of the neutral line 20 that is in contact with the temperature sensor 22 while maintaining the cross-sectional area of the neutral line (i.e., thinning that region).

Besides, the winding portion 24 may be formed by bending or curving the neutral line 20 in the width direction thereof. In this case, the neutral line 20 and the temperature sensor 22 extend in parallel with each other, and the curved region of the neutral line 20 can be made to extend along the outer periphery of the round bar or cylinder of the temperature sensor 22. Besides, the width can also be increased while maintaining the cross-sectional area.

The region of the neutral line that is in contact with the temperature sensor 22 is equal in cross-sectional area to the coil conductor 16, so that the electric current density of this region is equal to the electric current density of the coil conductor 16 of one phase. Thus, a temperature that is closer to the temperature of the coil conductor 16 can be detected.

The U-shaped region of the winding portion 24 can be arranged along a plane that intersects with the longitudinal direction of the rod-like temperature sensor 22, and especially in a plane that is perpendicular thereto. In the stator 10 of this rotary electric machine, the rod-like temperature sensor 22 is arranged along a plane that is perpendicular to the axis of rotation of the rotary electric machine, and accordingly, the U-shaped region of the winding portion 24 of the neutral line is arranged such that the direction along the axis of rotation coincides with the vertical direction. The arrangement of the U-shaped region of the winding portion 24 is changed in accordance with the arrangement of the temperature sensor 22. For example, in the case where the temperature sensor 22 is arranged in the direction along the axis of rotation, the U-shaped region can be arranged in the direction perpendicular to the axis of rotation.

The winding portion 24 of the neutral line and the region of the temperature sensor 22 around which this winding portion 24 is wound are embedded in a molded material 26 made of resin or the like. A mold is arranged in such a mariner as to surround the winding portion 24 and the aforementioned region of the temperature sensor 22, and liquid resin is injected into the mold and cured to form an embedded-type temperature detection portion 28. In other words, the embedded-type temperature detection portion 28 is formed through insert molding.

By adopting the embedded-type temperature detection portion 28, the accuracy of temperature measurement is enhanced in a liquid-cooled rotary electric machine. In the case of a liquid-cooled rotary electric machine, a cooling liquid is poured onto the coil 14 to carry out cooling. Thus, if the temperature sensor 22 and the neutral line 20 are exposed, the cooling liquid is poured onto them as well, and they are cooled. On the other hand, the region of the coil conductor 16 that reaches a high temperature is a region that is arranged in the slot 15 onto which the cooling liquid is not poured or is unlikely to be poured. Accordingly, if the cooling liquid is poured onto the temperature sensor 22 and the periphery thereof, the temperature of this region falls to deviate in temperature from the coil conductor 16. In the case of a liquid-cooled rotary electric machine as in this case, there are some cases where the temperature of the coil conductor 16 in the slot 15, which is actually desired to be known, cannot be accurately measured. In this stator 10, however, the embedded-type temperature detection portion 28 is employed. Consequently, the cooling liquid is not directly poured onto the temperature sensor 22 or the neutral line 20 therearound, and the temperature can be prevented from falling due to the cooling liquid.

The neutral line may have a bent region that is bent in the longitudinal direction thereof, and this bent region may be wound around the temperature sensor.

The region of the neutral line that is wound around the temperature sensor and the region of the temperature sensor, around which the neutral line is wound, may be embedded in a molded material.

What is claimed is:

1. A rotary electric machine comprising:
a coil conductor that is fitted to a core of the rotary electric machine to form a coil;
a neutral line connected to a neutral point of the coil; and
a temperature sensor, on which the neutral line is wound to be in contact therewith, and that detects a temperature of the neutral line, wherein
the neutral line is, in a region thereof that is in contact with the temperature sensor, equal in cross-sectional area to the coil conductor.

2. The rotary electric machine according to claim 1, wherein
the neutral line has a bent region that is bent in a longitudinal direction thereof, and
the bent region of the neutral line is wound around the temperature sensor.

3. The rotary electric machine according to claim 1, wherein
a region of the neutral line that is wound around the temperature sensor, and a region of the temperature sensor, around which the neutral line is wound, are embedded in a molded material.

4. The rotary electric machine according to claim 2, wherein
the neutral line is a flat-type conductor that is oblong in cross-section, and
the bent region of the neutral line is shaped along a contour of the temperature sensor.

5. The rotary electric machine according to claim 4, wherein
the temperature sensor has a round bar shape or a cylinder shape, and
the bent region of the neutral line is made arc or circular.

6. The rotary electric machine according to claim 1, wherein
the neutral line has a bent region that is bent in a width direction thereof, and
the bent region of the neutral line is wound around the temperature sensor.

7. The rotary electric machine according to claim 6, wherein
the neutral line is a flat-type conductor that is oblong in cross-section, and
the bent region of the neutral line is shaped along a contour of the temperature sensor.

8. The rotary electric machine according to claim 7, wherein
the temperature sensor has a round bar shape or a cylinder shape, and
the bent region of the neutral line is made arc or circular.
